(19) United States
(12) Patent Application Publication
(10) Pub. No.: US 2006/0118528 A1
(43) Pub. Date: Jun. 8, 2006

(54) Welding installation with narrow chamfers

(76) Inventors: Guillaume De Dinechin, Moulineaux (FR); Jean-Pascal Alfille, Clamart (FR); Gaspard De Bordas, St Gilles (FR); Philippe Aubert, Paris (FR)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/527,684

(22) PCT Filed: Sep. 25, 2003
(86) PCT No.: PCT/FR03/02825

§ 371 Date: Mar. 11, 2005

(30) Foreign Application Priority Data
Sep. 26, 2002 (FR) 02/11905

(51) Int. Cl. B23K 26/20

(52) U.S. Cl. 219/121.63; 219/121.64

(57) ABSTRACT

A welding head having an elongated shape enabling it to penetrate into narrow chamfers set up between two parts to be welded, and containing the end of a welding wire close to a laser beam to extend a molten pool and thus ensure a high quality welding operation even on edges of the chamfer.

The subject of this invention is a welding installation designed to work on joints with narrow chamfers.

When two thick parts have to be welded together, their junction faces are usually recessed and they are assembled forming a groove called a chamfer that extends over most of their thickness. Welding is done in successive passes, and a layer of filler metal is deposited in each pass to slowly fill the chamfer.

In practice, there are wide chamfers and narrow chamfers, and narrow chamfers typically have a half-opening which in relation to the depth corresponds to an inclination of not more 8° from the vertical. Narrow chamfers would be preferable because they would require less filler metal to fill them. However difficulties occur in practice when welding them; some traditional welding processes such as TIG (Tungsten Inert Gas) are slow (their advance rate is about 10 cm/min) and therefore they are not very suitable for satisfying productivity constraints in a process with multiple passes, and welding with a meltable electrode under a powder flow is fairly fast but is limited to horizontal joints due to the large molten pool volume. Note also MIG (Metal Inert Gas) and MAG (Metal Active Gas) processes that are also fast but in which the morphology of the molten pool may cause welding defects. The problem then encountered is identified in U.S. Pat. No. 4,891,494 A, weld beads deposited in sequence may reveal interstices on the sides of their junctions where they are connected to parts to be joined together, which affects the weld quality. The solution recommended in this patent is to replace the traditionally straight filler metal wire by a zigzag folded wire, the end of which is directed by the guide wire alternately on each side of the chamfer, to concentrate heat and the molten material and thus overcome welding defects on the sides.

However, it is by no means certain that a satisfactory result can always be obtained, since displacement of heat towards one side of the chamfer or the other reduces the temperature rise on the opposite side, and therefore can exaggerate the same defects on this opposite side. Moreover, a complex mechanism is necessary for shaping the wire.

The invention is based on a new concept for suitably making MIG or MAG type welds in narrow chamfers, according to which the dimensions of the molten pool are increased by a controlled additional heat input, due to a laser focused on the surface of the joint at the bottom of the chamfer. The productivity of the welding operation is very much better than with existing techniques.

This invention proposes an installation for welding in a chamfered joint comprising a laser, a filler metal wire and a wire guide electrode, characterised in that it comprises a head capable of penetrating into the chamfer, extended along the longitudinal and depth directions of the chamfer and narrow in a transverse direction of the chamfer, two central drillings passing through the head essentially in the depth direction, but converging towards each other under the head, one of the drillings being aligned with the laser and the other of the drillings containing the electrode, and two pipes for ejection of a protection gas passing through the head and ending up in front and behind the central drillings, in the longitudinal direction of the head.

The welding head penetrates into the chamfer and can advance guided by the chamfer, the melting means and the welding means remaining correctly positioned and the molten pool being protected on all sides from the external atmosphere either by the material of the parts to be joined together and the welding head, or by the protection gas occupying their interstices.

Advantageously, and arranged on the head, the installation comprises a micrometric table for adjusting the position of a laser optical head above the central drilling that is aligned with the laser, so that the position of the focal spot of the beam, and therefore the location of the molten pool, can be adjusted in a chamfer.

Advantageously the laser welding means are also chosen from among means using a YAG or CO₂ type source, and electric arc welding means are chosen from among the MIG or MAG type means.

The invention will now be described more fully and in all its aspects with reference to the following figures:

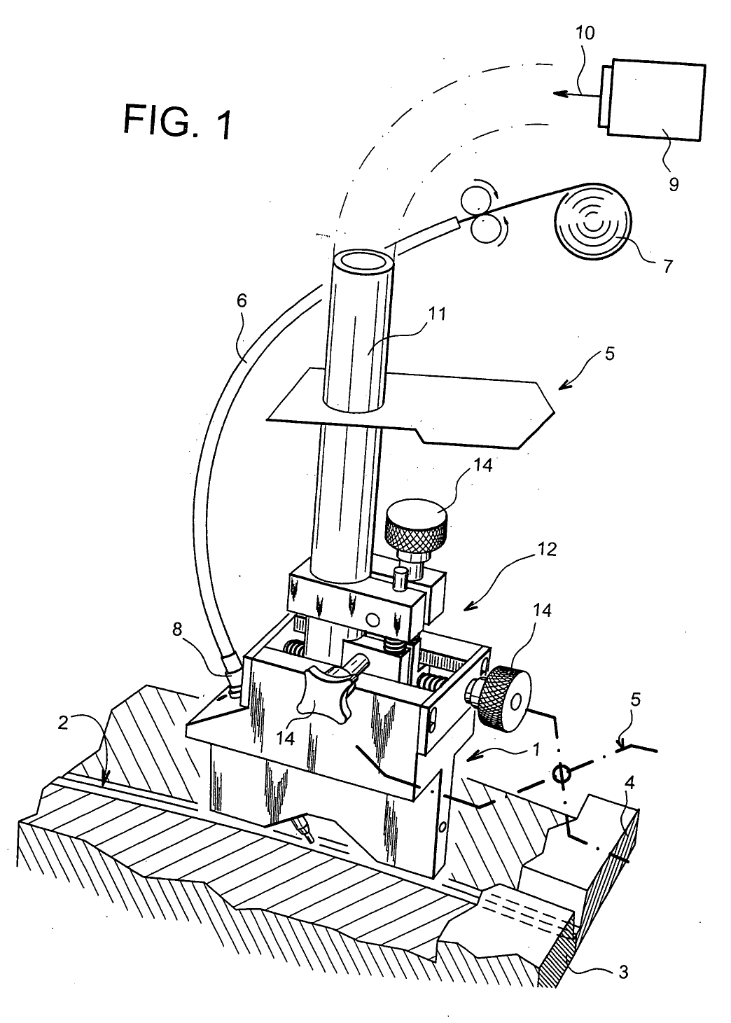

FIG. 1 is an overview of the invention,

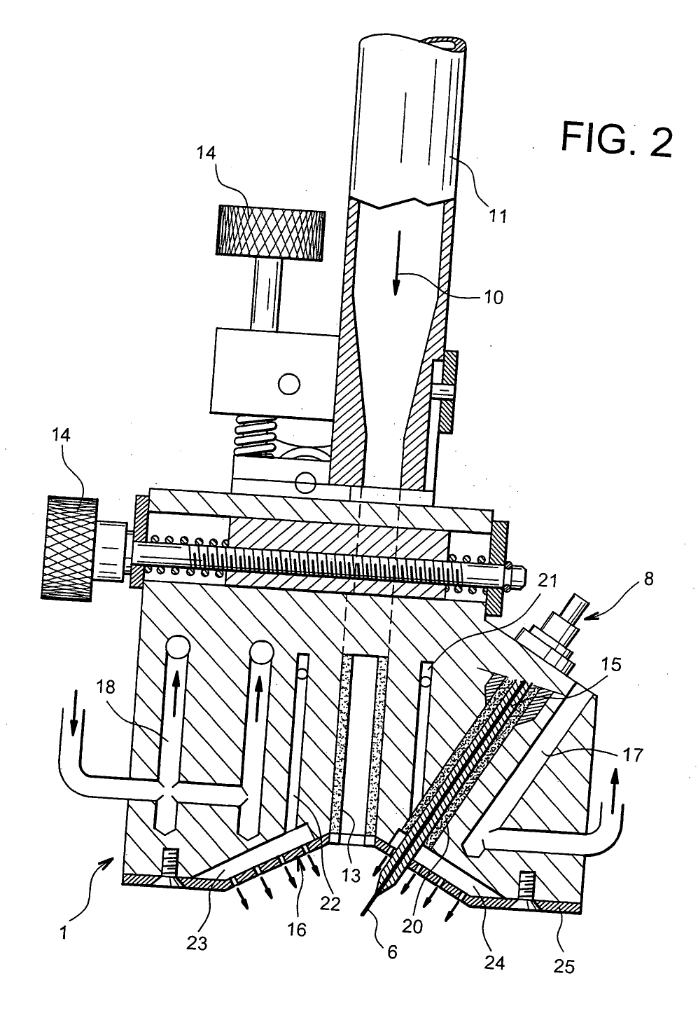

FIG. 2 is a sectional view through the head.

FIG. 1 firstly illustrates the essential elements of the invention: a head 1 moves in a chamfer 2 set up between two parts 3 and 4 to be welded, represented partially in a tear off view for reasons of clarity. The head 1 is displaced in the chamfer 2 by a robot arm 5 or other means; it has an elongated shape in the length and depth directions of the chamfer 2, but is narrow in the lateral direction so that it can penetrate into it. The filler metal is provided by a wire 6 unwound from a coil 7 and is guided in a tubular electrode 8, polarised with respect to parts 3 and 4 such that an electric arc can be formed between the parts and the end of the wire 6 according to the usual methods with MIG and MAG welding techniques. Finally, a laser 9 emits its beam 10 in an optical head 11. A micrometric adjustment table 12 is provided on the head 1 to move the focal position of the laser with respect to the rest of the head and thus adjust welding conditions.

With reference to FIG. 2, it can be seen that there is a central drilling 13 passing through the head 1 and extending in the vertical direction, or in the direction of the depth of the chamfer 2, and aligned with the optical head 11 and the laser beam 10, however the positions of the head may be adjusted in the three main directions by acting on the three knobs 14 of the table 12, which therefore displace the beam 10 with respect to the head 1. This provides a means of adjusting the position of the focal spot of the beam 10 and therefore the distribution of heat on parts 3 and 4 and over the molten pool.

The electrode 8 is tubular to guide the wire 6 and is placed in an insulating sleeve 20 that is engaged in another drilling 15 passing through the head 1 in a direction close to the direction of the first drilling 13 but converging towards it under the head 1, such that the end of the wire 6 arrives approximately along the centre line of the laser beam 10. At this location, the molten pool extends under the centre of the head 1, in a recess 16 formed in it. The electrode 8 extends as far as the recess 16 to reach a few centimetres from the bottom of the chamfer.

Two pipe networks 17 and 18 carry a cooling fluid at the front and back of the head 1 respectively on each side of the drillings 13 and 15, passing through the head 1; two gas ejection pipes 21 and 22 also pass through the head to protect the molten pool, and finish on corresponding chambers 23 and 24 respectively recessed under the head 1 at the inclined sides of the recess 16 on each side of the wire 6 and the beam 10. Good protection of the molten pool is thus obtained. A plate 25 fixed under the head 1 is perforated in front of chambers 23 and 24 to give good gas distribution. The blown gas occupies the entire recessed volume 16; the chambers 23 and 24 are fairly elongated in the longitudinal direction to cover the entire extent of the molten pool. The gas can leak laterally forwards from the front of the head 1 and backwards from the back, passing below the ends of the plate 25, which are parallel to and close to the bottom of the chamfer. It is thus certain that the air flow passes as far as the ends of the molten pool. It may be reinforced if the gas is still blown through a central duct, such as the central drilling 13, to provide an additional flow and also prevent the gas from escaping through the said central drilling 13 and escaping to the protective flow by leaking around the head 1. It becomes possible to weld by moving the head 1 in one direction or the other indifferently, due to its symmetrical structure around a longitudinal median plane.

The cooling fluid pipes 17 and 18 are recessed in the solid longitudinal ends of the head 1, on each side of the recess 16 and above the ends of the plate 25. Therefore, they can pass very close to the bottom of the head 1 where the temperature rise is greatest, and have a circulation length sufficient to assure dissipation of large quantities of heat.

1-5. (canceled)

6. An installation for welding in a chamfered joint
a laser;
a filler metal wire;
a wire guide electrode; and
a head configured to penetrate into the chamfer, extended along longitudinal and depth directions of the chamfer and narrow in a transverse direction of the chamfer, first and second central drillings passing through the head essentially in a depth direction, but converging towards each other under the head, the first drilling being aligned with the laser and the second drilling containing the wire guide electrode, and two pipes configured to eject a protection gas passing through the head and ending in front and behind the first and second central drillings.

7. A welding installation according to claim 6, further comprising a micrometric table, arranged on the head, for adjusting a position of the head above the first central drilling that is aligned with the laser.

8. A welding installation according to claim 6, wherein the head comprises a central recess in which the first and second central drillings end.

9. A welding installation according to claim 6, wherein the two pipes pass through the head in front and behind the first and second central drillings.

10. A welding installation according to claim 6, wherein the laser is chosen from among a YAG or CO₂ type source, and electric arc welding is chosen from among MIG or MAG type.

11. An installation for welding in a chamfered joint comprising:
a laser;
a filler metal wire;
a wire guide electrode; and
a head configured to penetrate into the chamfer, extended along longitudinal and depth directions of the chamfer and narrow in a transverse direction of the chamfer, first and second central drillings passing through the head essentially in a depth direction, but converging towards each other under the head, the first drilling being aligned with the laser and the second drilling containing the wire guide electrode, and two pipes configured to eject a protection gas passing through the head and ending in chambers located before and behind the first and second central drillings in the longitudinal direction and extending over a sufficient length in the longitudinal direction to completely cover a molten bath generated when the installation is in use.

12. A welding installation according to claim 11, further comprising a micrometric table, arranged on the head, for adjusting a position of the head above the first central drilling that is aligned with the laser.

13. A welding installation according to claim 11, wherein the head comprises a central recess in which the first and second central drillings end.

14. A welding installation according to claim 11, wherein the two pipes pass through the head in front and behind the first and second central drillings.

15. A welding installation according to claim 11, wherein the laser is chosen from among a YAG or CO₂ type source, and electric arc welding is chosen from among MIG or MAG type.

16. A method for welding in a chamfer joint with an installation including a laser, a filler metal wire, a wire guide electrode, a head configured to penetrate, into the chamfer, extending along longitudinal and depth directions of the chamfer and narrow in the transverse direction of the chamfer, first and second central drillings passing through the head essentially in a depth of direction, but converging towards each other under the head, the first drilling being aligned with the laser and the second drilling containing the wire guide electrode, and two pipes configured to eject a protection gas through the head and ending in chambers located before and behind the central drillings in the longitudinal direction and extending over a length in that direction, the method comprising:
blowing a protection gas through the pipes into the chambers;
lowering the head into the chamfer joint;
advancing the head along the chamfer joint; and
creating a molten bath under the head, the molten bath being completely covered by the chambers.
